(19) United States
(12) Patent Application Publication
(10) Pub. No.: US 2015/0058097 A1
(43) Pub. Date: Feb. 26, 2015

(54) METHOD AND SYSTEM FOR REWARDING INDIVIDUALS WITH REVENUE FOR VOTING ON ENTERTAINERS

(71) Applicant: MOHAMMED ABDULRAOUF ALTURKISTANI, Dubai (AE)

(72) Inventor: MOHAMMED ABDULRAOUF ALTURKISTANI, Dubai (AE)

(21) Appl. No.: 14/466,893

(22) Filed: Aug. 22, 2014

Related U.S. Application Data
(60) Provisional application No. 61/868,990, filed on Aug. 22, 2013.

(51) Int. Cl. G06Q 30/02; G07C 13/00

(52) U.S. Cl. CPC G06Q 30/0233; G07C 13/00
USPC 705/12

(57) ABSTRACT

Some embodiments provide a voting system and reward process for recognizing and rewarding fans for devotion to an entertainer. The voting system of some embodiments includes rewarding fans with monetary benefits and recognition. In some embodiments, the fans are one or more of viewers, listeners, and readers. In some embodiments, the monetary benefits are based on the value of an entertainment contract the entertainer enters into. In some embodiments, the entertainer is one or more of an actor, a singer, a writer, a director, a comedian, and a fine artist.

### CLAIM OF BENEFIT TO PRIOR APPLICATION

This application claims benefit to U.S. Provisional Patent Application 61/868,990, entitled “METHOD AND SYSTEM FOR REWARDING INDIVIDUALS WITH REVENUE FOR VOTING ON ENTERTAINERS,” filed Aug. 22, 2013. The U.S. Provisional Patent Application 61/868,990 is incorporated herein by reference.

### BACKGROUND

Embodiments of the invention described in this specification relate generally to revenue reward systems in the entertainment industry.

Many viewers, listeners, readers, and other individuals (hereafter referred to as “fans”) who are followers of an actors, singers, writers, comedians, and other entertainers (hereafter referred to as “entertainers”) are often in position to vote on, rate, or otherwise provide a systematic value for an entertainer based on a performance or a particular work item. Typically, however, fans are not rewarded for their votes. Instead, fans are provided the opportunity to vote and are simply expected to do so out of the genuine kindness of their heart or their passion for the entertainer. This is problematic for many fans who would like to be recognized for their vote. In many such cases, fans would like to be rewarded in some manner for casting a vote for an entertainer.

Although many fans peruse websites and other avenues for entertainment selections, the fans who routinely “like” an entertainer, give a thumbs-up (or down) to a movie associated with the entertainer, or otherwise vote in favor (or against) for an entertainer, typically the fan's interest and devotion dwindles over time. In many cases, an entertainer's popularity determines a large degree of the success that the entertainer enjoys. Thus, no entertainer wants to lose fans. When fans tire of their devotion to the entertainer with no reward or recognition, the entertainers would like a way to keep them in the circle. But aside from actually calling or emailing fans, most entertainers are hard-pressed to keep active fans interested in their works and performances. This is problematic for entertainers who hope to retain any previous fan and gain more fans and followers.

Thus, what is needed is a system in which fans who are typically never rewarded for their devotion to an entertainer, can obtain monetary benefits and recognition for voting and promoting the talents, works, and performance of the entertainer. The system must be able to reward true fans who noticed new talented entertainers from the start and stuck with them from the very beginning, and provide such recognition to true fans so that the entertainers will know who their first true fans were. In this way, the system can create new friendships and associations between the entertainer and the fans who help them out, where different friendship channels are established in which true fans can tell, write, and otherwise indicate directly to the entertainer how the entertainer might improve or change a performance or work.

### BRIEF DESCRIPTION

Some embodiments of the invention provide a novel entertainment promotion and fan voting and rewards system that promotes entertainment items associated with a set of entertainers and rewards a set of fans for supporting the entertainers. In some embodiments, the entertainment promotion and fan voting and rewards system allows fans to search for and select one or more entertainment items, review the selected entertainment items, and vote on one or more entertainers associated with the reviewed entertainment items. In some embodiments, the entertainment promotion and fan voting and rewards system rewards devoted fans of an entertainer with monetary benefits and fan recognition by the entertainer. In some embodiments, the entertainment promotion and fan voting and rewards system rewards a devoted fan of an entertainer with monetary benefits based on a monetary value of an entertainment contract the entertainer enters into. In some embodiments, the entertainment promotion and fan voting and rewards system rewards a devoted fan of an entertainer recognition that includes interactive communication with the entertainer.

Some embodiments include a fan voting and rewards process for recognizing and rewarding fans for devotion to an entertainer. The fan voting and rewards process of some embodiments provides a voting system for voting on an entertainment item associated with an entertainer, receiving a vote by a fan of the entertainer for the entertainment item, and tracking a set of votes by the fan for a set of other entertainment items associated with the entertainer. The fan voting and rewards process of some embodiments provides the voting system on a server and database that are accessible through a website on a web server that displays interactive tools to access and vote on the entertainment item. In some embodiments, the entertainment item is at least one of a live performance, a pre-recorded performance, a written work item, and an artistic media item. In some embodiments, a number of tracked votes qualifies the fan as a true fan. In some embodiments, the process provides a limited set of enhanced votes that a true fan is permitted to use during a pre-defined duration. The process of some embodiments rewards the true fan when the entertainer enters into an entertainment contract.

In some embodiments, the process includes signing into a fan account, searching for an entertainer that is worthy of receiving an enhanced vote, providing an enhanced vote in favor of the entertainer, waiting for the entertainer to get recognized, and receiving a monetary reward as a cut of a contract the entertainer enters into with the partner. In some embodiments, the monetary reward amount depends on whether the fan used enhanced votes in favor of the entertainer.

In some embodiments, the process provides an enhanced voting tool for true fans. In some embodiments, the enhanced voting tool allows the true fan to provide the highest form of rating on the website. The enhanced voting tool of some embodiments can only be used by the true fan once during a set duration. For instance, true fans might be accorded a single enhanced vote that allows the fan to cast multiple votes by a single vote. In some embodiments, the duration is one of an hour, a day, a week, a month, and a year. In other embodiments, the duration is a variably defined duration that periodically changes.

Additionally, fans can certify their approval of an entertainer by providing a “stamp-a-deal” vote or certification of approval for the entertainer. When a fan “stamps a deal” for an entertainer, in some embodiments, all of the entertainment items associated with the entertainer/talent display an icon or other marking that indicates that the fan certifies/approves of the entertainer. In this way, the “stamp a deal” approval from a fan provides “blanket” coverage of the fan's approval over all entertainment items from the entertainer.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a fan voting and rewards process in some embodiments for rewarding a fan of an entertainer with shared revenue derived from a contract of the entertainer.

FIG. 2 conceptually illustrates an entertainment promotion and fan voting and rewards system in some embodiments.

FIG. 3 conceptually illustrates a process for casting enhanced votes and setting an elevated fan status for a fan in relation to an entertainer in some embodiments.

FIG. 4 conceptually illustrates a process for identifying and tracking enhanced votes from fans in some embodiments of the entertainment promotion and fan voting and rewards system.

FIG. 5 conceptually illustrates an architecture of a revenue sharing management system in some embodiments that identifies, tracks, and manages future revenue streams associated with contracts from entertainers who were supported by devoted fans.

FIG. 6 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for many other uses.

Some embodiments of the invention provide a novel entertainment promotion and fan voting and rewards system that promotes entertainment items of entertainers and rewards some fans for supporting entertainers. Additionally, some embodiments include a fan voting and rewards process for recognizing and rewarding fans for devotion to an entertainer.

Several more detailed embodiments are described below. Section I describes a system and process for entertainment promotion and fan voting to promote entertainers/talents. Section II describes enhanced fan voting and revenue sharing. Section III describes an architecture of a revenue sharing management system that identifies, tracks, and manages future revenue streams associated with contracts from entertainers who were supported by devoted fans. Lastly, Section IV describes an electronic system that implements some embodiments of the invention.

### I. Entertainer Promotion by Fan Voting and Devotion Rewards

A. Entertainment Promotion and Fan Voting and Rewards System

In some embodiments, the entertainment promotion and fan voting and rewards system allows fans to search for and select one or more entertainment items, review the selected entertainment items, and vote on one or more entertainers associated with the reviewed entertainment items. In some embodiments, the entertainment promotion and fan voting and rewards system rewards devoted fans of an entertainer with monetary benefits and fan recognition by the entertainer. In some embodiments, the entertainment promotion and fan voting and rewards system rewards a devoted fan of an entertainer with monetary benefits based on a monetary value of an entertainment contract the entertainer enters into. In some embodiments, the entertainment promotion and fan voting and rewards system rewards a devoted fan of an entertainer recognition that includes interactive communication with the entertainer. Furthermore, the entertainment promotion and fan voting and rewards system of some embodiments ensures that entertainers will know who their first true fans are, thereby providing opportunities for creating new friendships between entertainers/talents and their fans.

In some embodiments, the entertainment promotion and fan voting and rewards system provides different types of entertainment items in different types of formats that can be reviewed and voted on by fans. Examples of the different types of entertainment items that are promoted by the entertainment promotion and fan voting and rewards system include, without limitation, entertainment items that are primarily visual entertainment items (e.g., comedic performances, independent film productions, theatrical performances, works of art, animations, etc.), entertainment items that are primarily audible entertainment items (e.g., songs and music recordings, voice impressions, book and poetry readings, etc.), and entertainment items that are primarily textual entertainment items (e.g., books, poetry, articles and blog commentary, movie and music reviews, etc.). Examples of the different types of formats used to provide the different types of entertainment items include, without limitation, visual formats (e.g., videos, individual images, slide show sequences, etc.), audio formats (e.g., uncompressed audio such as WAV or PCM, lossless compressed audio such as FLAC, lossy compressed audio such as MP3, etc.), textual formats (e.g., text files, rich text files, etc.), and mixed formats (e.g., portable document format (PDF) files with visual and textual items, image files with visual text and non-text items, e-book formatted files with visual, audible, and textual items, etc.).

In some embodiments, the entertainment promotion and fan voting and rewards system includes different sets of tools associated with the different types of formats to review the different types of entertainment items. In some embodiments, the different sets of tools include a set of visual viewing tools to view the visual entertainment items, a set of audio tools to listen to the audible entertainment items, and a set of reading tools to review the textual entertainment items.

Thus, entertainment items provided in visual formats (e.g., comedy videos, independent movies, theater videos, animation videos, slide show image sequences, art work images, etc.) can be viewed by fans using one or more of the visual viewing tools (e.g., video playback tool, image viewer tool, etc.). Entertainment items provided in audible formats (e.g., music recordings, monologue recordings, sound impressions, etc.) can be listened to by fans using one or more of the audio tools (e.g., music player tool, assisted text reader tool, sound amplifier tool, etc.). Entertainment items provided in textual formats (e.g., books, poetry, etc.) can be read by fans using one or more of the reading tools (e.g., e-book text display tool, document display tool, etc.). Entertainment items provided in mixed formats (e.g., comics with images and text, magazines with images and text, interactive e-books with images and/or videos, audio, and text, etc.) can be reviewed by fans using a combination of tools necessitated by the mixed formats of the entertainment items.

B. Fan Voting and Rewards Process

The fan voting and rewards process of some embodiments provides a voting system for voting on an entertainment item associated with an entertainer, receiving a vote by a fan of the entertainer for the entertainment item, and tracking a set of votes by the fan for a set of other entertainment items associated with the entertainer. The fan voting and rewards process of some embodiments provides the voting system on a server and database that are accessible through a website on a web server that displays interactive tools to access and vote on the entertainment item. In some embodiments, the entertainment item is at least one of a live performance, a pre-recorded performance, a written work item, and an artistic media item. In some embodiments, a number of tracked votes qualifies the fan as a true fan. In some embodiments, the process provides a limited set of enhanced votes that a true fan is permitted to use during a pre-defined duration. The process of some embodiments rewards the true fan when the entertainer enters into an entertainment contract.

In some embodiments, the process includes signing into a fan account, searching for an entertainer that is worthy of receiving an enhanced vote, providing an enhanced vote in favor of the entertainer, waiting for the entertainer to get recognized, and receiving a monetary reward as a cut of a contract the entertainer enters into with the partner. In some embodiments, the monetary reward amount depends on whether the fan used enhanced votes in favor of the entertainer.

In some embodiments, the process provides an enhanced voting tool for true fans. In some embodiments, the enhanced voting tool allows the true fan to provide the highest form of rating on the website. The enhanced voting tool of some embodiments can only be used by the true fan once during a set duration. For instance, true fans might be accorded a single enhanced vote that allows the fan to cast multiple votes by a single vote. In some embodiments, the duration is one of an hour, a day, a week, a month, and a year. In other embodiments, the duration is a variably defined duration that periodically changes.

Additionally, fans can certify their approval of an entertainer by providing a “stamp-a-deal” vote or certification for the entertainer. When a fan “stamps a deal” for an entertainer, in some embodiments, all of the entertainment items associated with the entertainer/talent display an icon or other marking that indicates that the fan certifies/approves of the entertainer. In this way, the “stamp a deal” approval from a fan provides “blanket” coverage of the fan's approval over all entertainment items from the entertainer.

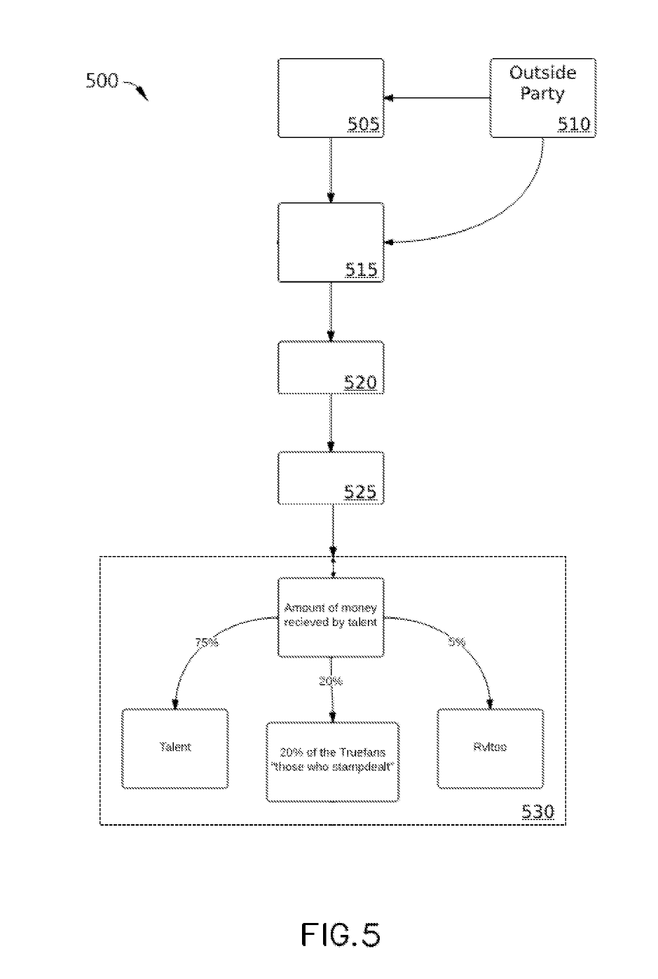

The reason to provide “stamp-a-deal” votes/certifications is that the fan may truly believe in an entertainer who is a new talent and who the fan believes will make it big someday. After a talent gets really famous those that stamped a deal for him/her will get rewarded with a percentage of their first deal, in a system where the talents agree to this deal upon signing up. This is described in further detail by reference to FIG. 5, below.

C. Examples of Entertainment Promotion and Fan Voting

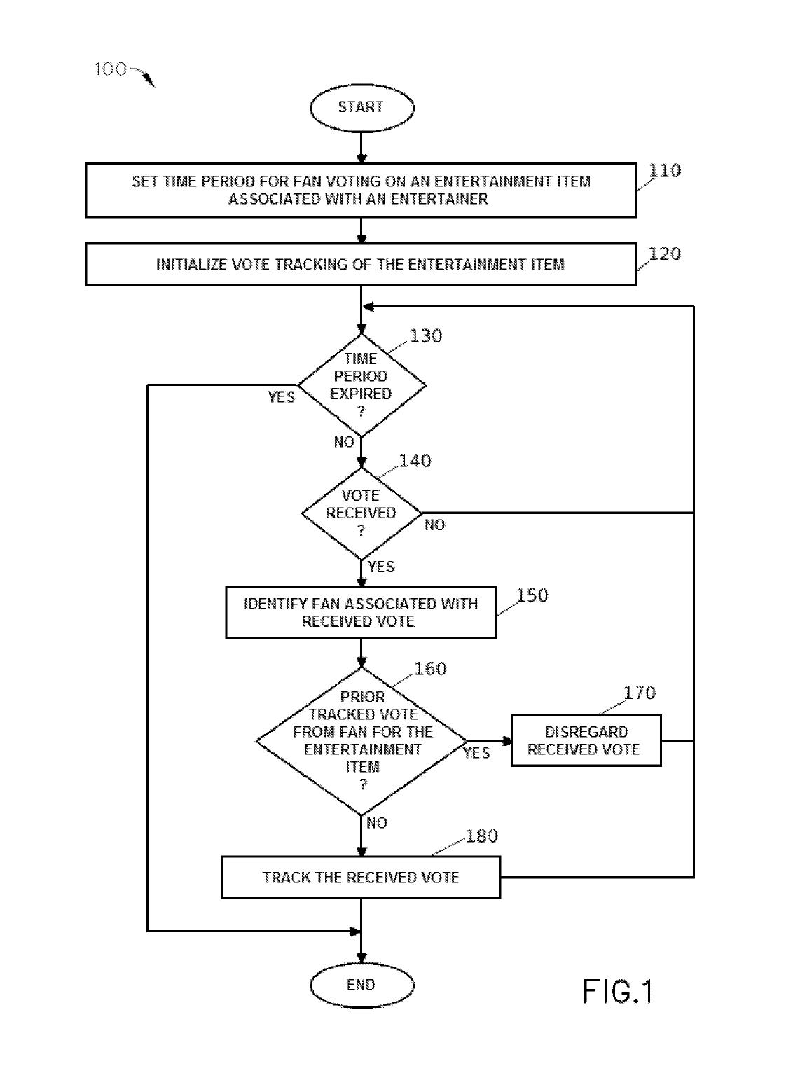

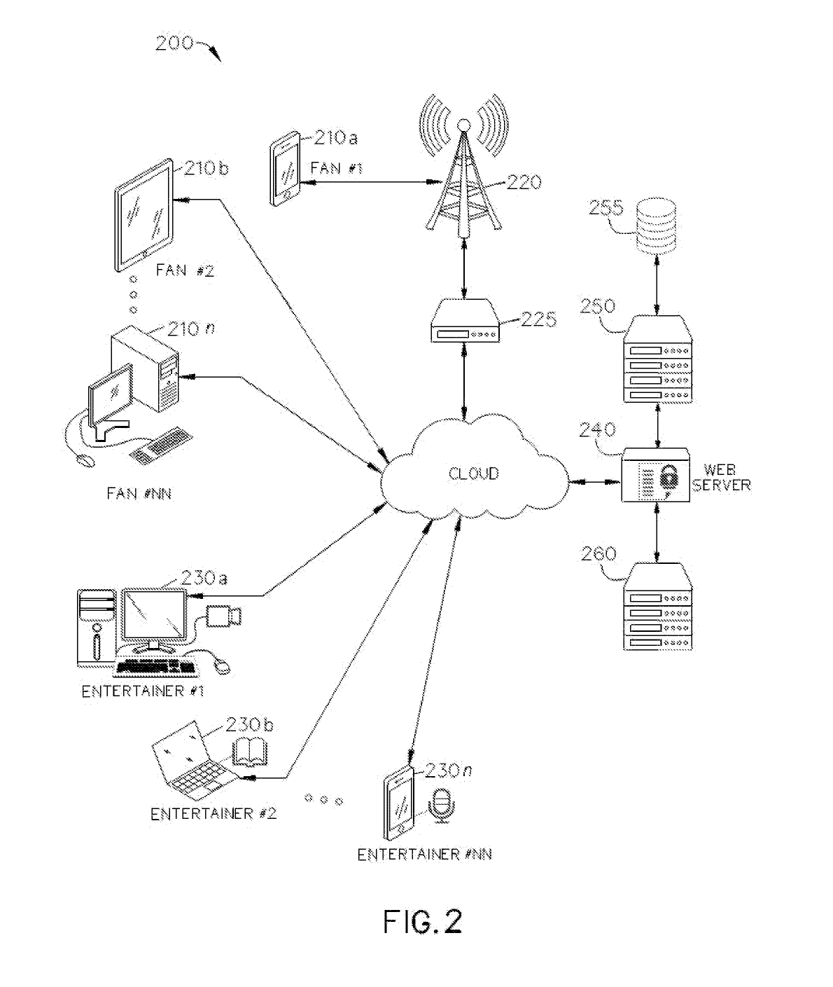

By way of example, FIG. 1 conceptually illustrates a fan voting and rewards process 100 for rewarding a fan of an entertainer with shared revenue derived from a contract of the entertainer. The fan voting and rewards process 100 includes several steps, which are described by reference to FIG. 2, which conceptually illustrates an entertainment promotion and fan voting and rewards system 200. In some embodiments, the fan voting and rewards process is performed by a program running on a server of an entertainment promotion and fan voting and rewards system. For example, the fan voting and rewards process 100 in FIG. 1 may be performed by the software program running on server 250 of the entertainment promotion and fan voting and rewards system 200 illustrated in FIG. 2.

Referring to FIG. 1, the fan voting and rewards process 100 starts by setting (at 110) a time period during which fan voting on a particular entertainment item associated with a particular entertainer will be allowed. For example, an entertainer may uploaded a video performance for fans to watch and vote on, and the process may set a voting duration of two weeks to allow the fans ample time to view the new video performance and cast a vote if they wish to.

Referring to FIG. 2, the entertainment promotion and fan voting and rewards system 200 includes a first set of computing devices 210a-210n associated with a set of fans (i.e., fan #1, fan #2, . . . , fan #nn), a second set of computing devices 230a-230n associated with a set of entertainers (i.e., entertainer #1, entertainer #2, . . . , entertainer #nn), a wireless communication point 220 (e.g., a cell tower for cellular data communication), a gateway 225, a web server 240, an entertainment promotion and fan voting server 250, an entertainment content database 255, and a fan rewards management system 260.

Examples of fans include, without limitation, viewers of entertainment items that are primarily visual, listeners of entertainment items that are primarily audible, readers of entertainment items that are primarily textual, and consumers of mixed media entertainment items. In some embodiments, a fan is rewarded monetary benefits based on a monetary value of an entertainment contract the entertainer enters into. Examples of entertainers include, without limitation, actors, singers, comedians, impersonators, stage performers (e.g., dancers, acrobats, mimes, etc.), writers, directors, fine artists, etc. As shown in FIG. 2, one might assume that entertainer #1 performs visual entertainment (e.g., acting, stand-up comedy, etc.), entertainer #2 may be a writer (i.e. as illustrated by the book related to computing device 230b), and that entertainer #nn performs audible entertainment (e.g., singing, monologue speaking, impersonating, etc.). On the other hand, the fans (i.e., fan #1, fan #2, . . . , fan #nn) could be interested in any type of entertainment content and would only be limited by the capabilities of the computing device the fan uses to access the entertainment item. For example, fan #1 may find it difficult to read textual entertainment items because the display screen of mobile computing device 210a is relatively small compared to the display screens of computing devices 210b and 210n. Similarly, fan #nn may not be able to hear audible entertainment items if, for example, computing device 210n does not include a speaker.

As shown in FIG. 2, entertainer #1 may record a new video performance and transmit the new video over the Internet (i.e., “cloud”) from computing device 230a to the entertainment promotion and fan voting server 250. The web server 240 may require entertainer #1 to log onto the system with a set of authentication credentials (for example, username and password) and then may provide access (via one or more uploading tools) to the entertainment promotion and fan voting server 250 and the entertainment content database 255 in which to store the new video. When the new video is stored in the content database 255, the entertainment promotion and fan voting server 250 will open a voting period during which any of the fans (i.e., fan #1, fan #2, . . . , fan #nn) can access and view the new video, and vote on the new video.

Referring back to FIG. 1, the fan voting and rewards process 100 initializes (at 120) vote tracking of the entertainment item. Tracking votes from fans includes tracking which fans have voted (to prevent double voting) and tracking how many votes have been cast. For example, many fans may vote on the entertainment item and some fans may use enhanced votes that increase the number of effective votes being cast by the vote. Next, the fan voting and rewards process 100 determines (at 130) whether the voting time period (set at 110) has expired. When the process 100 determines that time has expired for voting on the entertainment item, the process 100 simply transitions to the end, where voting is no longer permitted.

When the process 100 determines that the voting period is still active, the process 100 will then determine (at 140) whether a vote for the entertainment item is received. When no vote is received, the process 100 transitions back to 130 to determine whether the time period is expired. On the other hand, when a vote is received, the process 100 identifies (at 150) the fan associated with the received vote. Next, the fan voting and rewards process 100 determines (at 160) whether the fan associated with the received vote has already cast a vote that was tracked for the entertainment item. When the process 100 determines that the fan has already cast a vote for the entertainment item, the process 100 disregards (at 170) the received vote from the fan (i.e., does not track the vote). On the other hand, when the process 100 determines that the fan has not cast a vote for the entertainment item, the process 100 then tracks (at 180) the received vote for the entertainment item.

Referring to FIG. 2, in order for fans to vote on an entertainment item or entertainer during an open voting period, each fan must log onto the system and use one or more voting tools displayed on the website served by the web server 240. Once logged onto the system, the fan can be identified and any votes of the fan can be tracked. For example, for fan #nn to vote on the new video uploaded from computing device 230a by entertainer #1, fan #nn may use computing device 210b to access the system login website served by the web server 240, and once authenticated by the web server 240, fan #2 may use a search tool or directory tool on the website to access the new video of entertainer #1, use a video playback tool on the website to watch the new video, and use one or more voting tools to cast a vote for the new video. The vote tracking operations of the software running on the server 250 will attempt to validate the vote from fan #2 by cross checking a list of fans who have already voted on the new video in order to ensure that fan #2 has not already cast a vote for the new video. Once the server 250 validates the vote cast by fan #2, the software tracks the vote for the new video and adds fan #2 to the list of fans who have already voted on the new video. In some embodiments, the website served by the web server 240 displays a graphic of the total number of votes that have been cast by fans for entertainment items. In some embodiments, the website updates the graphic in real-time to display an accurate number of total votes cast for an entertainment item (i.e., after each vote is cast, validated, and tracked).

Referring back to FIG. 1, after tracking the received vote, the fan voting and rewards process 100 transitions back to 130 to determine whether the voting period has expired. At the point when the voting period expires, the process 100 then ends. In other words, voting for the entertainment item ends. However, there may be other ongoing voting periods for other entertainment items, and future voting can be initialized for future uploaded entertainment items.

The examples described by reference to FIGS. 1 and 2, above, illustrate how the entertainment promotion and fan voting and rewards system provides a voting system for fans to vote on entertainment items and support entertainers in ways that go beyond mere content voting systems which currently exist. In the next section, more detailed examples of enhanced voting and fan reward distribution are described.

### II. Enhanced Voting and Revenue Rewards

Current voting systems do not provide any rewards for the fans for what they truly deserve, because true fans help out talents by providing them word of mouth which is the highest and best form of marketing thus far today. Every famous person out there owes a big part of their fame to those few true fans that spread the word out when they were nobodies and slowly it reaches from fan to fan and the word spreads out more and more my system rewards the ones that started the word of mouth for the talent and calling them true fans.

The voting system of some embodiments creates (1) motivation for users/fans to find new entertainers/talents, (2) after stamping a deal voting in favor of a talent, provides a chat option to the fan that is enabled between the fan and the talent on a website or mobile phone, and thereby creates a new relationship between talents and fans, allowing talents to know who are their real true fans are, and (3) people will be judged solely on their talent and have the chance to become famous without spending any money and time for example not going through the hassle of promoting and marketing themselves.

One particular feature is the unique enhanced vote (e.g., as is known by the trade name, “stampTdeal”) that people won't be able to use only once a month, then it is a waiting game as to whether the user/fan invested in someone worthy enough to make it or not. If the talent gets recognized, the user will get rewarded if not they have another chance every month.

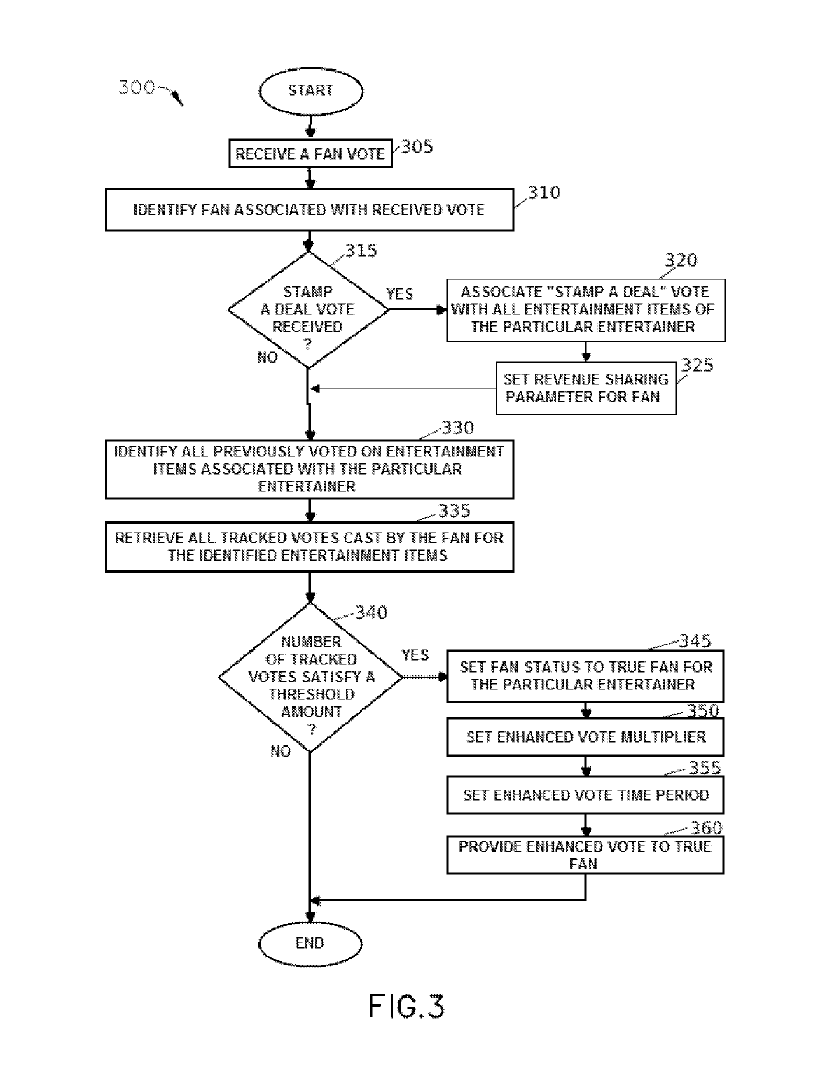

By way of example, FIG. 3 conceptually illustrates a process 300 for casting enhanced votes and setting an elevated fan status for a fan in relation to an entertainer in some embodiments. The process 300 is performed by a program running on the entertainment promotion and fan voting server 250, described above by reference to FIG. 2.

As shown in this figure, the process 300 starts by receiving (at 305) a fan vote. The process then identifies (at 310) the fan associated with the received vote. Next, the process 300 determines (at 315) whether the vote cast by the fan is a special “stamp a deal” vote. When the fan cast a special “stamp a deal” vote, the process 300 associates (at 320) the “stamp a deal” special vote with the entertainer and all entertainment items of the entertainer. In other words, a special “stamp a deal” vote casts a carpet vote over all the entertainment items of the entertainer. Additionally, when a fan “stamps a deal” for a particular entertainer, the fan will be eligible to share in revenue which may be received from the entertainer, should the entertainer end up entering into a talent contract. Thus, the process 300 would then set (at 325) a revenue sharing parameter for the fan in relation to the entertainer. In this way, a fan may be motivated to identify good entertainers in the hopes of such entertainers landing a contract, making the fan eligible to receive a revenue cut of the contract.

On the other hand, when the process 300 determines that the received vote is not a “stamp a deal” special vote, the process 300 then identifies (at 330) all previously cast votes by fan for entertainment items associated with the particular entertainer. Next, the process 300 retrieves (at 335) all tracked votes cast by the fan for the identified entertainment items. The process then determines (at 340) whether the number of tracked votes by the fan for entertainment items of the particular entertainer satisfies a threshold amount of votes. For example, if the entertainment promotion and fan voting and rewards system sets a threshold amount of votes to 75% of the entertainment items of any entertainer, then any fan who has voted in favor of at least 75% of a particular entertainer's items would satisfy the threshold.

When the threshold is not satisfied, the process 300 simply ends. However, when the threshold is satisfied, the process 300 then sets (at 345) the fan's status to “true fan” in relation to the particular entertainer. In some embodiments, the process 300 then sets (at 350) an enhanced vote multiplier. The enhanced vote multiplier, in some embodiments, increases the weight of each vote the fan casts in relation to entertainment items of the particular entertainer. For example, the enhanced vote multiplier may be set to two, which would effectively double each vote the fan makes for entertainment items of the particular entertainer. In this way, the entertainment promotion and fan voting and rewards system rewards the fan for the fan's support and devotion to the particular entertainer.

However, in some embodiments, the enhanced vote multiplier is constrained by one or both of time and amount. As shown in the next step, process 300 sets (at 355) the enhanced vote time period. For example, the system may limit use of the enhanced vote to a one week period, after which the enhanced vote, if not used, would be rendered void. Next, the process 300 provides (at 360) the enhanced vote to the fan with “true fan” status. This allows the fan to use the enhanced vote in relation to any entertainment items associated with the particular entertainer which the fan has not already voted for. Also, the system may limit the number of enhanced votes awarded to the fan. For example, the system may limit each fan to a maximum of one enhanced vote per month, in relation to any entertainer. After providing the enhanced vote, the process 300 ends.

As noted above, all previous voting systems have failed to reward those who vote, because none of them have provided monetary rewards or even rewards in general. In contrast, by providing opportunities to share in revenue streams derived from contracts entertainers may enter into, and by providing status changes the allow fans to increase the weight of their votes (and thereby increase their influence in promoting entertainers), the entertainment promotion and fan voting and rewards system encourages genuine voting of content creators and entertainment items from entertainers, and motivates fans to get involved in promoting entertainers who they feel may have what it takes to land a contract. In addition, by constraining the usage of enhanced votes, the system is able to reduce or prevent gaming of the system by fans. Thus, the system overall indicates true feelings of how fans feel about specific entertainers and their associated entertainment items.

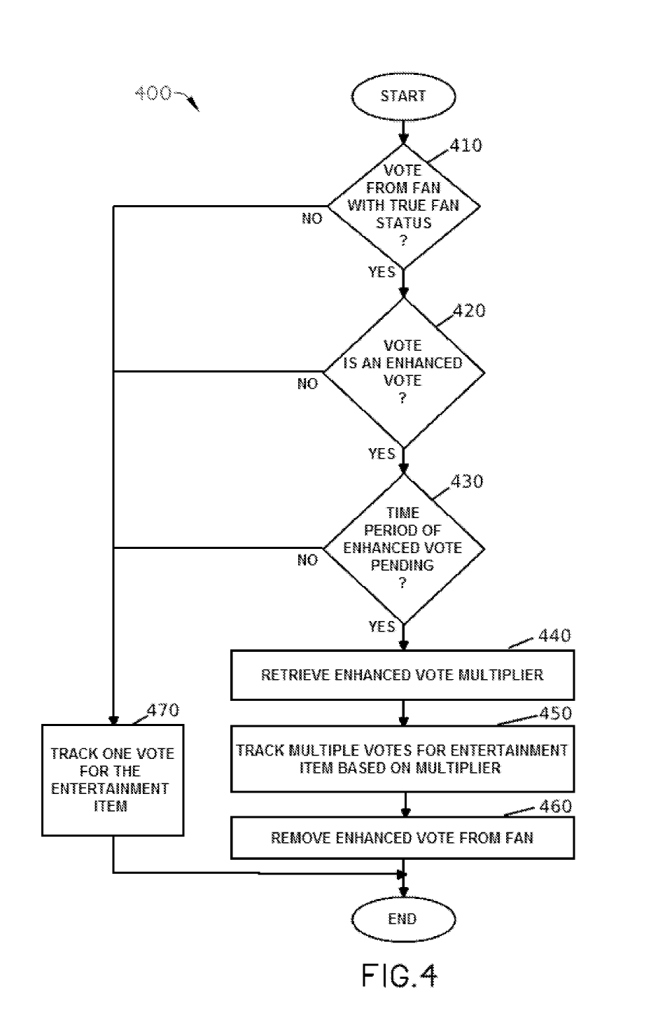

By way of example, FIG. 4 conceptually illustrates a process 400 for identifying and tracking enhanced votes from fans in some embodiments of the entertainment promotion and fan voting and rewards system. The process 400 is performed in some embodiments by a software program running on the entertainment promotion and fan voting server 250 described above by reference to FIG. 2. The process 400 starts upon receiving a vote from a fan. Thus, the process 400 initially determines (at 410) whether the received vote was cast by a fan with “true fan” status. In some embodiments, a fan with “true fan” status may have an enhanced vote to cast. When the fan does not have “true fan” status, the process 400 simply tracks (at 470) a single vote for the entertainment item for which the received vote was cast.

On the other hand, when the fan is a “true fan”, the process 400 then determines (at 420) whether the received vote is an enhanced vote. Tracking enhanced votes, as noted above by reference to FIG. 3, would require the system to determine the value of the enhanced vote multiplier associated with the “true fan” enhanced vote. When the “true fan” has cast a vote that is not an enhanced vote, the process 400 simply tracks (at 470) one vote for the entertainment item. However, when the received vote is an enhanced vote, the process 400 then determines (at 430) whether a time period for using the enhanced vote is pending or expired. When the time period is determined to have expired, the process 400 transitions to 470 in order to track a single vote because the enhanced vote's multiplier evaporated upon the end of the usable time period (which was described above by reference to FIG. 3).

In contrast, when the usable voting period of the enhanced vote is still pending, the process 400 then retrieves (at 440) the enhanced vote multiplier associated with the enhanced vote. Next, the process 400 tracks (at 450) multiple votes for the entertainment item based on the weight of the multiplier. For example, if the multiplier for the enhanced vote is three, then the received vote is tracked as three votes for the entertainment item to the benefit of the entertainer. After tracking the number of votes corresponding to the enhanced vote, the process removes (at 460) the enhanced vote from a voting tool box associated with the “true fan”. The process 400 then ends.

### III. Management of Future “Stamp a Deal” Revenue Streams

Some embodiments of the entertainment promotion and fan voting and revenue sharing system include a sub-system for managing future revenue streams related to contracts which supported entertainers/talents have entered into after getting supported by one or more fans. In some embodiments, the sub-system is a revenue sharing management system comprising a set of revenue sharing management computing devices and servers. Referring to FIG. 2, the entertainment promotion and fan voting and revenue sharing system 200 includes the fan rewards management system 260. The fan rewards management system 260 is connected to the web server 240, as shown in FIG. 2. In addition, one or more other computing devices (not shown) outside of the entertainment promotion and fan voting and revenue sharing system 200 interact with the fan rewards management system 260 either directly or indirectly through the Internet (i.e., “cloud”).

By way of example, FIG. 5 conceptually illustrates an architecture of a revenue sharing management system 500 in some embodiments that identifies, tracks, and manages future revenue streams associated with contracts from entertainers who were supported by devoted fans. In some embodiments, the revenue sharing management system includes a set of programs that run on one or more computing devices of the revenue sharing management system 500 and perform one or more processes which in combination allow the revenue sharing management system 500 to play a managerial role after an entertainer/talent receives a certain number of “stamp a deal” certifications (i.e., special “blanket” votes) from fans. For example, if an entertainer has received at least ten “stamp a deal” certifications from fans, the revenue sharing management system 500 may then manage certain aspects of future contract revenue stream distributions.

As shown in this figure, the revenue sharing management system 500 includes a special vote tracking module 505 that tracks “stamp a deal” special votes for each entertainer/talent. In some embodiments, a user interface of the website served by the web server 240 indicates the number of “stamp a deal” votes received by any entertainer. Thus, different users and parties may assess the talent of certain entertainers and thereby express some interest in the entertainers. Thus, one or more outside parties 510 recognize a particular entertainer/talent based on seeing and assessing the numbered of “stamp a deal” votes shown by way of the tracking module 505. The outside parties 510 may then engage in discussions by way of a deal negotiator engine 515 that is part of the revenue sharing management system 500. In some embodiments, the deal negotiator engine 515 tracks deal discussions and details after a human actor inputs notes and discussion details into a computing device with a software application that accesses the deal negotiator engine 515 running on a server of the fan rewards management system 260.

In some embodiments, the revenue sharing management system 500 includes an agreement lock-in tool 520 that generates a set of documents and contract provisions associated with details of the negotiations to which all parties agree. In some embodiments, the agreement lock-in tool generates a first contract between the outside party 510 and the entertainer/talent and a second contract between the entertainer/talent and a party associated with the revenue sharing management system 500. In some other embodiments, the agreement lock-in tool generates a single final contract naming the entertainer, the outside party 510, and the party associated with the revenue sharing management system 500 as three parties to the same contract. In such a contract, provisions related to the distribution of revenue from the contract is provided in express provisions.

When printed and signed by all parties to the contract, a contract archive module 525 receives a scanned copy of the signed contract, associated a unique contract index number to the completed contract, and stores the scanned copy of the completed contract in a storage database. In some embodiments, the unique contract index number assigned by the contract archive module 525 cross references one or more contract numbering systems associated with the entertainer personally, the outside party, and any internal indexing system for storing physical copies of contracts.

The revenue sharing management system 500 also includes a fund distribution system 530 which receives an amount associated with the revenue received by the entertainer/talent computes the associated revenue streams for each party to the contract based on the break-down of revenue agreed by the parties and locked-into the contract, and distributes the associated funds to the corresponding party. In this example, the entertainer/talent receives 75% of the distributed revenue from the outside party 510, while 20% goes to “true fans” who provided the “stamp a deal” certifications of the entertainer/talent, and the party associated with the revenue sharing management system 500 receives the remaining 5% of the revenue from the contract.

In some embodiments, the number of “true fans” who provided “stamp a deal” certifications of the entertainer may be more than the minimum number of “stamp a deal” certifications needed for the entertainer to qualify for assistance via the revenue sharing management system 500. For example, the revenue sharing management system 500 may require at least 10 “stamp a deal” votes for an entertainer to qualify, but an entertainer may have already received 20 or more “stamp a deal” votes from 20 or more fans. Whatever the number of “stamp a deal” certifications and “true fans” associated with an entertainer, the revenue sharing management system 500 of some embodiments sub-divides the amount of revenue going to “true fans” according to rules of distribution which vary among different embodiments of the revenue sharing management system 500. For example, in some systems, a 20% cut of the money for “true fans” is divided equally between the fans, while in some other systems, the 20% cut is divided disproportionately, such that “true fans” who cast “stamp a deal” votes earlier than other “true fans” would qualify to receive a high percentage of the 20% cut. In this way, the system encourages fans to act quickly to identify true talent among the entertainers who utilize the system to promote their creative works and careers.

### IV. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

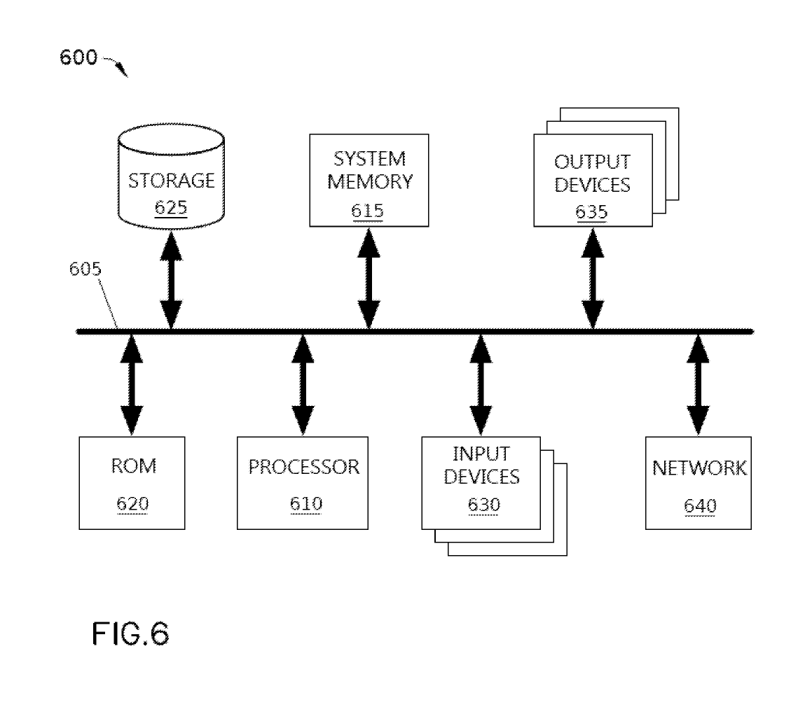

FIG. 6 conceptually illustrates an electronic system 600 with which some embodiments of the invention are implemented. The electronic system 600 may be a computer, phone, PDA, or any other sort of electronic device. Such an electronic system includes various types of computer readable media and interfaces for various other types of computer readable media. Electronic system 600 includes a bus 605, processing unit(s) 610, a system memory 615, a read-only 620, a permanent storage device 625, input devices 630, output devices 635, and a network 640.

The bus 605 collectively represents all system, peripheral, and chipset buses that communicatively connect the numerous internal devices of the electronic system 600. For instance, the bus 605 communicatively connects the processing unit(s) 610 with the read-only 620, the system memory 615, and the permanent storage device 625.

From these various memory units, the processing unit(s) 610 retrieves instructions to execute and data to process in order to execute the processes of the invention. The processing unit(s) may be a single processor or a multi-core processor in different embodiments.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 625.

Other embodiments use a removable storage device (such as a floppy disk or a flash drive) as the permanent storage device 625. Like the permanent storage device 625, the system memory 615 is a read-and-write memory device. However, unlike storage device 625, the system memory 615 is a volatile read-and-write memory, such as a random access memory. The system memory 615 stores some of the instructions and data that the processor needs at runtime. In some embodiments, the invention's processes are stored in the system memory 615, the permanent storage device 625, and/or the read-only 620. For example, the various memory units include instructions for processing appearance alterations of displayable characters in accordance with some embodiments. From these various memory units, the processing unit(s) 610 retrieves instructions to execute and data to process in order to execute the processes of some embodiments.

The bus 605 also connects to the input and output devices 630 and 635. The input devices enable the user to communicate information and select commands to the electronic system. The input devices 630 include alphanumeric keyboards and pointing devices (also called “cursor control devices”). The output devices 635 display images generated by the electronic system 600. The output devices 635 include printers and display devices, such as cathode ray tubes (CRT) or liquid crystal displays (LCD). Some embodiments include devices such as a touchscreen that functions as both input and output devices.

Finally, as shown in FIG. 6, bus 605 also couples electronic system 600 to a network 640 through a network adapter (not shown). In this manner, the computer can be a part of a network of computers (such as a local area network (“LAN”), a wide area network (“WAN”), or an intranet), or a network of networks (such as the Internet). Any or all components of electronic system 600 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1 and 3-4 conceptually illustrate processes in which the specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which, when executed by at least one processing unit of a computing device, rewards fans for devotion to an entertainer, said program comprising sets of instructions for:
authenticating a set of fan login data for signing into a fan account;
identifying an entertainer that is worthy of receiving a vote;
providing the vote in favor of the entertainer;
waiting for the entertainer to get recognized; and
receiving a monetary reward as a cut of a contract the entertainer enters into with the partner.

2. The non-transitory computer readable medium of claim 1, wherein the set of instructions for identifying the entertainer comprises a set of instructions for reviewing an entertainment item associated with the entertainer.

3. The non-transitory computer readable medium of claim 2, wherein the entertainment item is a video, wherein the set of instructions for reviewing the entertainment item comprises a set of instructions for playing the video in a video playback tool.

4. The non-transitory computer readable medium of claim 2, wherein the entertainment item is an audio item, wherein the set of instructions for reviewing the entertainment item comprises a set of instructions for playing the audio item in an audio player tool.

5. The non-transitory computer readable medium of claim 2, wherein the entertainment item is a textual item, wherein the set of instructions for reviewing the entertainment item comprises a set of instructions for opening the textual item in a document display tool.

6. The non-transitory computer readable medium of claim 1, wherein the set of instructions for authenticating the set of login data comprises a set of instructions for receiving the set of login data at a web server computing device.

7. An entertainment promotion and fan voting and rewards system that promotes entertainment items associated with a set of entertainers and rewards a set of fans for supporting the entertainers, said system comprising:
a web server computing device that receives login credentials from fans and entertainers and authentications the login credentials to provide access to a set of entertainment content items;
an entertainment content item data storage unit that stores the set of entertainment content items;
an entertainment promotion and fan voting server computing device comprising a processor, a memory unit, and a software program to provide (i) an entertainment promotion platform in which entertainers can upload entertainment content items to the data storage unit and (ii) a voting platform in which fans can vote on entertainment items in order to promote entertainers;
a website that is hosted by the web server and provides a user interface that allows fans and entertainers to access and use the system, said user interface comprising a set of entertainment content item uploading tools, a set of voting tools, and a set of entertainment content item access tools; and
a revenue sharing management system comprising (i) a set of computing devices that monitor interest in a particular entertainer by an outside party, (ii) a set of computing devices that facilitates creation of a contractual agreement between the entertainer and the outside party, and (iii) a set of computing devices that calculate contract revenue percentages to distribute to the entertainer and a set of fans devoted to the entertainer.

8. The entertainment promotion and fan voting and rewards system of claim 7, wherein the web server computing device receives the login credentials from a computing device associated with one of a fan and an entertainer.

9. The entertainment promotion and fan voting and rewards system of claim 7, wherein the entertainment promotion and fan voting server computing device further comprises a database management program to (i) store entertainment content items that were uploaded by entertainers into the data storage unit and (ii) retrieve entertainment content items for review by fans accessing the entertainment content items with the set of entertainment content item access tools provided by the website.

10. The entertainment promotion and fan voting and rewards system of claim 7, wherein the set of voting tools comprises (i) a standard voting tool that casts a single vote for an entertainment item, (ii) an enhanced voting tool that casts a weighted vote that is a multiple of a single vote for an entertainment item, and (iii) a certified approval vote that casts a blanket vote of approval for all entertainment content items associated with a particular entertainer.
